(19) United States
(12) Patent Application Publication
(10) Pub. No.: US 2011/0289457 A1
(43) Pub. Date: Nov. 24, 2011

(54) ELECTRONIC READING APPARATUS AND METHOD FOR PREVIEWING FILES

(75) Inventors: XIAO-GUANG LI, Shenzhen City (CN); HONG-YE LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/978,325

(22) Filed: Dec. 23, 2010

(30) Foreign Application Priority Data
May 18, 2010 (CN) 201010175693.X

(51) Int. Cl. G06F 3/048

(52) U.S. Cl. 715/838

(57) ABSTRACT

An electronic reading apparatus includes a storage unit storing electronic files and thumbnails corresponding to the electronic files, a display unit displaying thumbnails of a desired electronic file and a desired page associated with one of the thumbnails. In addition, a processing unit configured for: entering a preview mode; searching all titles of the desired electronic file and enlarging the titles and preselected contents while reducing the other contents to generate thumbnails of pages containing the titles of the electronic file. Searching a page associated with a selected thumbnail according to input operation, and displaying the desired page on the display unit. A method for previewing files is also provided.

### BACKGROUND

1. Technical Field

The present disclosure relates to electronic reading apparatuses and, particularly, to an electronic reading apparatus and a method for previewing files.

2. Description of the Related Art

Mechanical buttons are usually provided on an electronic device for users to flip through an electronic file displayed on the electronic device. However, repeated pressing of the buttons may cause the users to feel tired and bored.

### BRIEF DESCRIPTION OF THE DRAWINGS

The components of the drawings are not necessarily drawn to scale, the emphasis instead being placed upon clearly illustrating the principles of an electronic reading apparatus and a method for previewing files. Moreover, in the drawings, like reference numerals designate corresponding parts throughout multiple views.

FIG. 1 is a schematic view of page thumbnails displayed on an electronic reading apparatus in accordance with an exemplary embodiment.

FIG. 2 is a block diagram of the electronic reading apparatus of FIG. 1.

FIG. 3 is a flowchart of a method for previewing files applied in the electronic reading apparatus of FIG. 1 in accordance with an exemplary embodiment.

### DETAILED DESCRIPTION

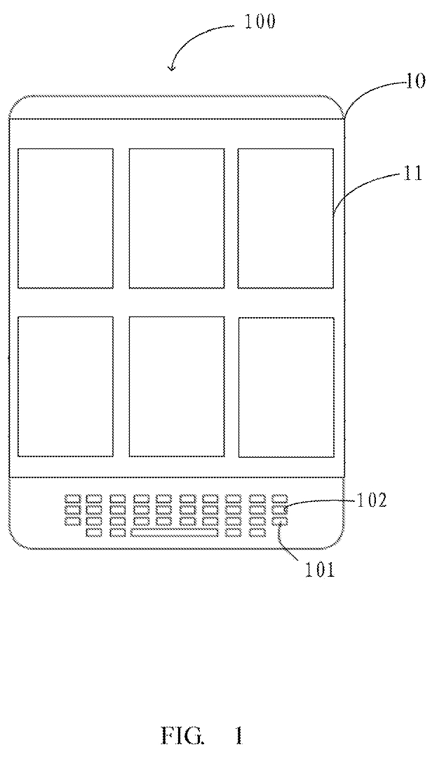

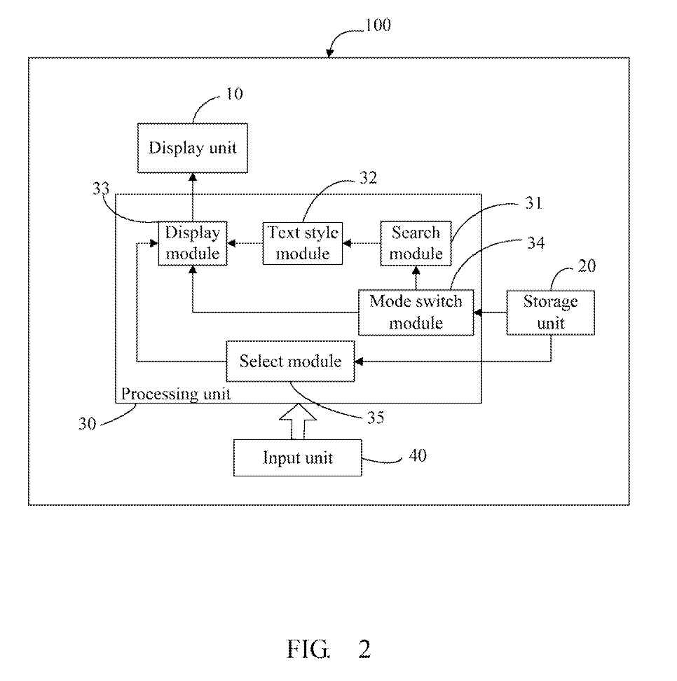

Referring to FIGS. 1 and 2, an electronic reading apparatus 100 includes a display unit 10, a storage unit 20, a processing unit 30, and an input unit 40. In this embodiment, the electronic reading apparatus 100 may be a mobile phone, an E-book, or even an audio player which provides electronic files for users to read.

The storage unit 20 stores electronic files and thumbnails 11 corresponding to the electronic files.

The input unit 40 generates input signal in response to user input. In the embodiment, the input unit 40 may include a mode button 101 and selection buttons 102. The mode button 101 generates mode signals for switching modes of the electronic reading apparatus 100. In the present embodiment, the electronic reading apparatus 100 includes a reading mode and a preview mode. The electronic reading apparatus 100 displays a page of an electronic file for users to read under the reading mode and displays thumbnails 11 of the electronic file under the preview mode. The selection buttons 102 generates selection signals for opening a desired page corresponding to a selected thumbnail 11. Thus, users can quickly find the desired page using the thumbnails 11 of an electronic file. In one embodiment, the selection buttons 102 are four direction buttons provided for users to move a cursor on the display unit 10 to accurately select a desired thumbnail 11.

The processing unit 30 includes a search module 31, a text style module 32, a display module 33, a mode switch module 34 and a selection module 35. The mode switch module 34 determines whether the electronic reading apparatus 100 enters the reading mode or the preview mode according to the mode signals of the switch button 101. The display module 33 displays a page of an electronic file after the electronic reading apparatus 100 enters the reading mode and displays a number of thumbnails 11 of the electronic file after the electronic reading apparatus 100 enters the preview mode.

In detail, after the electronic reading apparatus 100 enters the reading mode according to the mode signal, the display module 33 reads and displays a file list or listing icons of stored electronic files to provide a selection of desired files for the users. The display module 33 further displays a page of a selected file according to user selection.

After the electronic reading apparatus 100 enters the preview mode according to the mode signal. The mode switch module 34 determines whether thumbnails 11 of a desired electronic file selected by a user exist in storage of the electronic reading apparatus 100, if so, the mode switch module 34 reads the thumbnails 11 and the display module 33 displays the thumbnails on the display unit 10 to provide preview of the electronic file for the users. The user can also operate a button on the electronic reading apparatus 100 to update the thumbnails 11. The button provided for updating the thumbnail 11 can be the mode button 101 or another button, such as a button especially configured for updating the thumbnail 11. After receiving the request of updating the thumbnail 11, the search module 31 searches all the titles in the electronic file. The search module 31 searches the titles by identifying a unique identification of each of the titles, and extracts the pages containing each of the titles and transmits the pages to the text style module 32. In the embodiment, different formats of files, such as TXT files, PDF files and HLP files, may have their own ways to indicate titles in the files. Therefore, the search module 31 needs to identify the format of the electronic file first, and then search the corresponding unique identifications of the titles of the electronic files according to the format of the electronic file.

The text style module 32 generates thumbnails 11 of the pages. In the thumbnails 11, the titles and preselected contents are enlarged while the other contents are reduced, that is, font size of the titles and the preselected contents are enlarged, so that they can be read by users. The font sizes of the other contents on the pages are reduced to save room for displaying the enlarged items, i.e., the titles and the preselected contents. In this embodiment, the preselected content is the contents immediately following the titles. For example, the preselected content is the first paragraph following the titles. In another embodiment, the preselected content is selected portions of the first paragraph. In still another embodiment, the preselected content is given numbers of words immediately following a title.

If no thumbnail exists for the electronic file, the mode switch module 34 signals the search module 31 to search all the titles in the electronic file. The search module 31 searches the titles by the unique identifications of those titles and extracts the pages containing the titles and transmits the pages to the text style module 32. In an alternative embodiment, the text style module 32 generates thumbnails 11 of the pages containing the titles of the electronic files. The text style module 32 only enlarges titles and predetermined contents on the thumbnails 11. If a thumbnail has enlarged items, other contents in this thumbnail will have a reduced font size, to save room for displaying of the enlarged items.

The select module 35 further searches a page associated with a selected thumbnail 11 according to input operation on the thumbnails 11; the display module 33 displays the page on the display unit 10.

In another embodiment, the text style module 32 can change color or font style, or both the color and the font style of the titles and the preselected content, so that the titles and the preselected content can be identified and read by users.

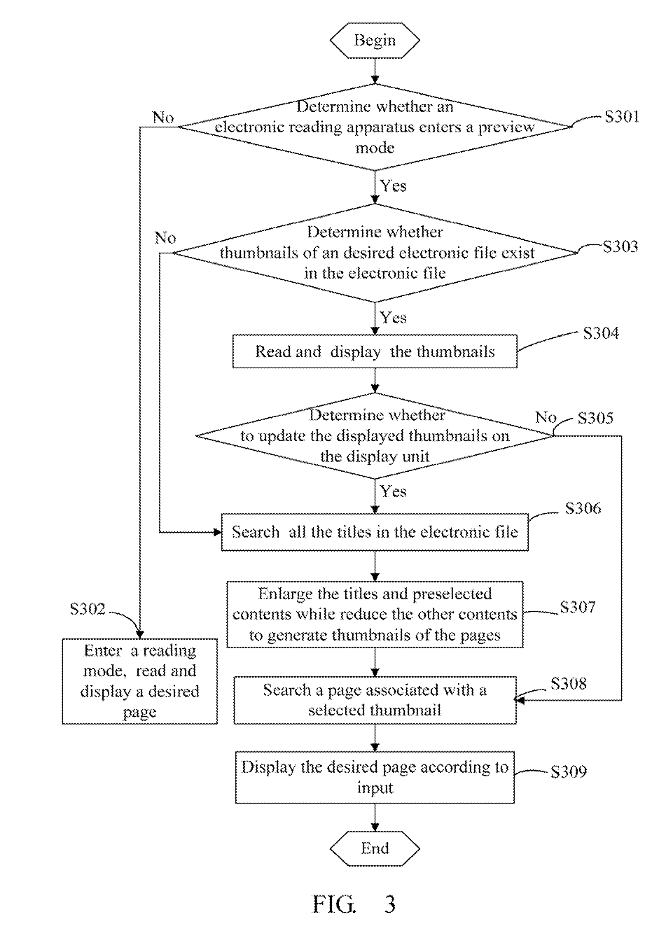

Referring to FIG. 3, showing a previewing method of the electronic reading apparatus 100 in accordance with an exemplary embodiment.

In step S301, the mode switch module 34 determines whether the electronic reading apparatus 100 enters a preview mode or a reading mode. In the embodiment, the mode switch module 34 controls the electronic reading apparatus 100 to enter the reading mode and/or enter the preview mode according to the mode signal of the mode button 101.

In step S302, the display module 33 displays a page of a desired electronic file if the electronic reading apparatus 100 enters the reading module.

In step S303, the mode switch module 34 determines whether thumbnails 11 of pages of the desired electronic file selected by a user exist for the electronic file if the electronic reading apparatus 100 enters the preview mode.

In step S304, the mode switch module 34 reads the thumbnails 11 and the display module 33 displays the thumbnails 11 on the display unit 10 to provide preview of the electronic file for users if the thumbnails 11 of the electronic files exists in the electronic file, otherwise, implementing the step S306.

In step S305, the mode switch module 34 further determines whether a request for updating the thumbnails 11 is received. In the embodiment, user can operate a button on the electronic reading apparatus 100 to request for updating the thumbnails 11.

If a request for updating the thumbnails 11 is received, in step S306, the mode switch module 34 signals the search module 31 to search all the titles in the electronic file. Otherwise, implementing step S308. In the embodiment, the search module 31 searches the titles by unique identifications of the titles.

In step S307, the text style module 32 generates thumbnails 11 of pages containing the titles of the electronic file. On the thumbnails 11 where the titles appear, the titles and preselected contents are enlarged and the other contents will be reduced. In other embodiments, the pages include those where titles appear and those where titles are absent.

In step S308, the select module 35 searches a page associated with a selected thumbnail 11 if the select module 35 receives a select signal of a thumbnail 11 according to input operation.

In step S309, the display module 36 displays the desired page on the display unit 10.

In this embodiment, the electronic reading apparatus 100 and method for previewing files, the processing unit 30 enlarges titles and predetermined contents following the titles on the thumbnails 11, so users can quickly preview and find out a desired page.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic reading apparatus, comprising:
a storage unit configured for storing electronic files and thumbnails corresponding to the electronic files;
a display unit configured for displaying thumbnails of an desired electronic file and a desired page associated with one of the thumbnails; and
a processing unit configured for:
entering a preview mode;
searching all titles of the desired electronic file and enlarging the titles and preselected contents while reducing the other contents to generate thumbnails of pages containing the titles of the electronic file;
searching a page associated with a selected thumbnail according to input operation; and
displaying the desired page on the display unit.

2. The electronic reading apparatus as described in claim 1, wherein the processing unit is also configured for entering a reading mode and displaying a page of a desired electronic file on the display unit.

3. The electronic reading apparatus as claimed in claim 2, wherein the processing unit is further configured for reading and displaying a file list or listing icons of stored electronic files to provide a selection of the desired electronic file for users before displaying the page of the desired electronic on the display unit.

4. The electronic reading apparatus as claimed in claim 1, wherein the input unit comprises a mode button and selection buttons; the mode button is configured for generating mode signals for switching the processing unit between the preview mode and the reading mode; the selection buttons is configured for generating selection signals for opening a desired page corresponding to a selected thumbnail.

5. The electronic reading apparatus as described in claim 1, wherein the processing unit comprises a search module configured for searching all titles of the desired file according to unique identifications of the titles.

6. The electronic reading apparatus as described in claim 5, wherein the search module is further configured for identifying the format of the desired electronic file to identify the unique identifications of the titles before searching the titles according to the unique identifications thereof.

7. The electronic reading apparatus as described in claim 1, wherein the preselected contents are contents immediately following the titles.

8. The electronic reading apparatus as described in claim 7, wherein the contents immediately following the titles are the first paragraphs following the titles.

9. The electronic reading apparatus as described in claim 7, wherein the contents immediately following the titles are portions of the first paragraphs following the titles.

10. The electronic reading apparatus as described in claim 7, wherein the contents immediately following the titles are given number of words following the titles.

11. A method for previewing files applied in an electronic reading apparatus, comprising:
determining whether the electronic reading apparatus enters a preview mode;
searching all titles of an desired electronic file if the electronic reading apparatus enters preview mode;
enlarging the titles and preselected contents to generate thumbnails of pages containing the titles of the desired electronic file;
searching a page associated with a selected thumbnail according to input operation; and
displaying the desired page on the display unit.

12. The method as described in claim 11, wherein the pages are those where the titles appear, and contents excepting the titles and the preselected contents in the thumbnails are reduced in size.

13. The method as described in claim 11, wherein the pages comprises those where the titles appear and those where titles are absent, and the contents in the thumbnails where the titles appear excepting the titles and the preselected contents are reduced in size.

14. The method as described in claim 11, wherein the preselected contents are the contents immediately following the titles.

15. The electronic reading apparatus as described in claim 14, wherein the contents immediately following the titles are the first paragraphs following the titles.

16. The electronic reading apparatus as described in claim 14, wherein the contents immediately following the titles are portions of the first paragraphs following the titles.

17. The electronic reading apparatus as described in claim 14, wherein the contents immediately following the titles are given number of words following the titles.

18. An electronic reading apparatus comprising a preview mode in which thumbnails of pages of the desired electronic file are displayed, and in the thumbnails, titles and preselected contents are enlarged for users to read.

19. The electronic reading apparatus as described in claim 18, wherein the pages are those where the titles appear and the contents except the titles and the preselected contents are reduced in size.

20. The electronic reading apparatus as described in claim 18, wherein the pages comprise those containing the titles and those containing no titles, and in the thumbnails for pages containing the titles, contents except the titles and the preselected contents are reduced in size.
